(19) United States
(12) Patent Application Publication
(10) Pub. No.: US 2020/0182737 A1
(43) Pub. Date: Jun. 11, 2020

(54) LEAKAGE INSPECTION DEVICE FOR CONTAINER, LEAKAGE INSPECTION METHOD FOR CONTAINER, AND CONVEYED CONTAINER PROCESSING DEVICE

(71) Applicant: TOYO SEIKAN CO., LTD., Tokyo (JP)

(72) Inventors: Masashi AOKI, Kanagawa (JP); Osamu HATANO, Kanagawa (JP); Kiyohito GONDOU, Fukuoka (JP); Hironori OZEKI, Tokyo (JP)

(73) Assignee: TOYO SEIKAN CO., LTD., Tokyo (JP)

(21) Appl. No.: 16/343,315

(22) PCT Filed: Oct. 27, 2017
(86) PCT No.: PCT/JP2017/038916

§ 371 Date: Apr. 18, 2019

(30) Foreign Application Priority Data
Nov. 11, 2016 (JP) 2016-220559
Feb. 14, 2017 (JP) 2017-025287

(51) Int. Cl. G01M 3/32

(52) U.S. Cl. CPC G01M 3/3209

(57) ABSTRACT

To enable a leakage inspection even without considering a change in a container temperature. A leakage inspection device includes a head mounting part that mounts inspection heads respectively on mouth parts of containers among containers alignedly conveyed from a container manufacturing line, a pressure supplying part that simultaneously feeds a supply pressure to the inspection heads respectively mounted on the containers to control pressure in the sealed containers to an inspection pressure, and a leakage determination part that detects a pressure change over time in the sealed containers and performs leakage determination of the containers. The leakage determination part includes a differential pressure sensor that detects a differential pressure in a pair of containers of the plurality of containers. The leakage determination part performs the leakage determination on the basis of an output of the differential pressure sensor.

### TECHNICAL FIELD

The present invention relates to an inspection device and an inspection method for inspecting a leakage of a container on a downstream side of a container manufacturing line or a processing device that performs processing such as inspection, cleaning, and filling in a container on a downstream side of a container manufacturing line.

### BACKGROUND ART

On a downstream side of a container manufacturing line of a synthetic resin bottle, a can, and the like processing such as leakage inspection processing for inspecting whether a manufactured container has predetermined airtightness, cleaning processing for removing dust in the container, and filling processing for filling content fluid and the like in the container is performed. In such processing, a processing head (an inspection head, etc.) is mounted on a mouth part of a conveyed container, thereafter the processing head is retained for a fixed time, and the processing such as the leakage inspection is performed while the processing head is retained.

In the leakage inspection, the inspection head is mounted on the mouth part of the container, pressurizing air is supplied into the container in a sealed state to apply an inspection pressure in the container, thereafter the sealed state is maintained for a fixed time, and presence or absence of a leakage is determined from a pressure drop amount of a container internal pressure detected while the sealed state is maintained.

In the conventional technique described in Patent Literature 1 described below, a bottle made of synthetic rein is set as a target, an inspection head is mounted on a bottle mouth part, a supply valve is opened for a predetermined time, a bottle internal pressure immediately after the supply valve is closed is set as a reference internal pressure, whether or not the reference internal pressure exceeds a predefined first threshold is checked, when the reference internal pressure exceeds the first threshold, an air sealed state of the bottle is maintained for a fixed time, a pressure drop amount of the bottle internal pressure from the reference internal pressure after elapse of the fixed time is measured by a differential pressure sensor, and, when the pressure drop amount does not exceed a predefined second threshold, the bottle is determined as a non-defective product (with no leakage).

The conventional technique described in Patent Literature 2 described below is a leakage inspection device, the leakage inspection device including conveying means for conveying a container and following means for causing an inspection head to follow a container transferred in order to mount an inspection head on a mouth part of the container and including equal-interval disposing means for disposing conveyed containers at equal intervals in order to simultaneously mount a plurality of inspection heads on a plurality of containers and gripping means for positioning the containers at the equal intervals.

### CITATION LIST

### Patent Literature

PTL 1: Japanese Patent Application Laid-Open No. 2009-109259
PTL 2: Japanese Patent Application Laid-Open No. 2004-117135

### SUMMARY OF INVENTION

### Problem to be Solved by the Invention

A temperature change in which the temperature of a container gradually drops from a high-temperature state to a normal temperature occurs on a downstream side of a container manufacturing line. For example, in a synthetic resin bottle, the bottle immediately after being taken out from a blow mold has high temperature of approximately 40 to 50° C. in a body and has approximately 30° C. in a leakage inspection device inlet on the downstream side of the container manufacturing line. Thereafter, in a process of conveyance, the temperature of the bottle drops to the normal temperature (approximately 25° C.).

When a leakage inspection is performed on the downstream side of the container manufacturing line, it is necessary to sufficiently consider the temperature change of the container. A pressure drop amount from the reference internal pressure decreases when the temperature of the container is high. Therefore, the threshold in the leakage inspection described above needs to be set to a value considering the temperature of the container.

The temperature of the body of the bottle flowing to the leakage inspection device is approximately 30° C. as described above during continuous production. However, when the container manufacturing line temporarily stops and restarts, a bottle having temperature near the normal temperature sometimes flows to the leakage inspection device. Therefore, complicated adjustment, such as setting of a wide threshold corresponding to all temperature ranges or change of the threshold as appropriate according to the temperature of the bottle in the leakage inspection device inlet, is necessary. Thus, there is a problem in that a leakage inspection with high productivity cannot be performed.

The present invention has been proposed to cope with such a problem. That is, a first object of the present invention is to perform a highly accurate leakage inspection with high productivity even without considering a change in a container temperature in a leakage inspection of a container on a downstream side of a container manufacturing line.

In the processing for the container explained above, in order to improve a processing ability, it is necessary to simultaneously process a plurality of containers. For example, in a leakage inspection device, it is necessary to elongate an inspection time in order to detect a gentle pressure change due to the presence of a very small leakage hole. Therefore, in order to improve the processing ability, it is required to simultaneously mount a plurality of processing heads on mouth parts of a plurality of containers and perform the leakage inspection.

In the conventional technique described in Patent Literature 2, in order to simultaneously mount a plurality of inspection heads on mouth parts of a plurality of linearly conveyed containers, an equal interval disposing means (a star wheel) for disposing the containers at equal intervals is provided first and thereafter gripping means for positioning intervals of the containers, which fluctuate because of vibration or the like before mounting the inspection heads on the containers passing through the equal interval disposing means, at equal intervals again is provided. When the gripping means for positioning the containers at the equal intervals again after the containers pass through the equal interval disposing means in this way, the leakage inspection device or the like increases in size and cost. When a container size is changed, a model change of the gripping means is necessary. Thus, there is a problem in that the productivity is deteriorated. Therefore, it is required to surely mount inspection heads (processing heads) respectively on the plurality of containers without using means for positioning the containers at equal intervals even if there is fluctuation in the intervals between the containers.

The present invention has been proposed to solve such a problem. That is, a second object of the present invention is to, in a processing device that performs processing such as a leakage inspection on conveyed containers, surely mount processing heads respectively on a plurality of containers without using means for positioning the containers at equal intervals even if there is fluctuation in intervals of the containers.

### Means for Solving the Problem

In order to solve the first problem explained above, a leakage inspection device for container according to the present invention includes the following configuration.

A leakage inspection device for container includes: a head mounting part that mounts inspection heads respectively on mouth parts of a plurality of containers among containers alignedly conveyed from a container manufacturing line; a pressure supplying part that simultaneously feeds a supply pressure to the inspection heads respectively mounted on the plurality of containers to control pressure in the plurality of sealed containers to an inspection pressure; and a leakage determination part that detects a pressure change over time in the plurality of sealed containers and performs leakage determination of the plurality of containers. The leakage determination part includes a differential pressure sensor that detects a differential pressure in a pair of containers of the plurality of containers. The leakage determination part performs the leakage determination based on an output of the differential pressure sensor.

In order to solve the second problem explained above, a conveyed container processing device of the present invention includes the following configuration.

A conveyed container processing device includes: a container sensor that detects a linearly conveyed container; a plurality of head mounting parts that mount processing heads respectively on mouth parts of a plurality of containers detected by the container sensor; a plurality of linear actuators that reciprocally transfer the head mounting parts along a conveyance path of the containers; and a controller that respectively individually controls operations of the plurality of linear actuators and the plurality of head mounting parts. The controller respectively recognizes positions of the plurality of containers conveyed from detection timing of the container sensor and a transfer distance of the containers and controls the linear actuators to transfer the processing heads respectively onto the plurality of containers detected by the container sensor and thereafter cause the head mounting parts to follow the transfer of the containers.

### Effects of the Invention

The leakage inspection device for containers of the present invention detects a differential pressure in a pair of containers of a plurality of containers among containers alignedly conveyed from the container manufacturing line and performs leakage determination. Container temperatures of the pair of containers of the plurality of containers among the alignedly conveyed containers are substantially equal. Therefore, by detecting the differential pressure in the containers, it is possible to perform highly accurate leakage detection with high productivity without considering a change in the container temperatures.

The differential pressure in the pair of containers has a small range of a detected pressure change irrespective of the size of the containers. Therefore, by associating the small range of the pressure change with a full range of the differential pressure sensor, it is possible to detect a very small pressure change with high sensitivity. This also makes it possible to perform highly accurate leakage determination.

Even when there is fluctuation in the intervals of the linearly conveyed containers, the conveyed container processing of the present invention can transfer the respective processing heads to the positions of the respective containers detected by the container sensor and mount the processing heads on the plurality of conveyed containers. This makes it possible to improve the processing ability by simultaneously processing the plurality of containers. It is also possible to surely mount the processing heads on the plurality of containers without using means for positioning the containers at equal intervals even if there is fluctuation in the intervals of the containers. Therefore, it is possible to achieve improvement of productivity such as a reduction in a model change time.

The processing device can be externally set without changing the existing conveyance device. Therefore, the processing device can be disposed at low cost.

### BRIEF DESCRIPTION OF THE DRAWINGS

FIG. 1 is an explanatory diagram showing a configuration example of a leakage inspection device for containers according to an embodiment of the present invention.

FIG. 2 is an explanatory diagram showing a setting example of the leakage inspection device for containers according to the embodiment of the present invention.

FIG. 3 is an explanatory diagram showing a determination example of presence or absence of a leakage by the leakage inspection device for containers according to the embodiment of the present invention.

FIG. 4 is an explanatory diagram showing an overall configuration of a conveyed container processing device according to the embodiment of the present invention.

FIG. 5 is a side view showing a main part of the conveyed container processing device according to the embodiment of the present invention.

FIG. 6 is a bottom view showing a main part of the conveyed container processing device according to the embodiment of the present invention.

FIG. 7 is an explanatory diagram showing the operation of the conveyed container processing device according to the embodiment of the present invention (FIG. 7(a) shows a state immediately after one processing is ended, FIG. 7(b) shows a state immediately before the next processing is performed, and FIG. 7(c) shows a state during the processing).

### DESCRIPTION OF EMBODIMENTS

Embodiments of the present invention are explained below with reference to the drawings. In the following explanation, the same signs in different figures indicate parts having the same functions. Redundant explanation of the parts in the figures is omitted as appropriate.

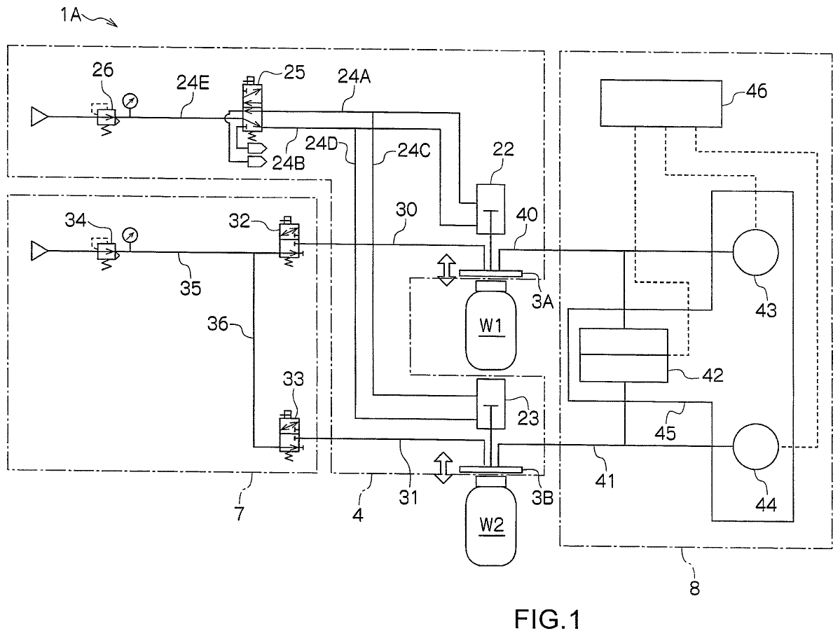

As shown in FIG. 1, a leakage inspection device for containers (hereinafter, leakage inspection device) 1A includes a head mounting part 4, a pressure supplying part 7, and a leakage determination part 8. Inspection targets are a plurality of containers W1 and W2 alignedly conveyed from a container manufacturing line. The target containers W1 and W2 only have to be capable of securing sealability by closing the mouth parts. Various containers such as a synthetic resin bottle, a metal can, a metal bottle can, and a pouch can be set as targets. This embodiment is based on the premise that containers simultaneously set as inspection targets by the leakage inspection device 1A are the plurality of neighboring containers W1 and W2 among containers alignedly conveyed from the container manufacturing line and container temperatures of these containers are substantially equal.

The head mounting part 4 has a function of mounting inspection heads 3A and 3B respectively on the mouth parts of the inspection target containers W1 and W2. The inspection heads 3A and 3B respectively close the mouth parts of the containers W1 and W2. End portions of pressure supplying pipes 30 and 31 connected to the pressure supplying part 7 and pressure detecting pipes 40 and 41 connected to the leakage determination part 8 are connected to the inspection heads 3A and 3B. Consequently, when the inspection head 3A (3B) is mounted on the mouth part of the container W1 (W2), the mouth part is sealed. The end portions of the pressure supplying pipe 30 (31) and the pressure detecting pipe 40 (41) communicate with the container W1 (W2).

A specific configuration example of the head mounting part 4 shown in FIG. 1 is explained. The head mounting part 4 includes air cylinders 22 and 23 for lifting and lowering the inspection heads 3A and 3B. Pipes 24A and 24B for causing air cylinders to operate are connected to the air cylinder 22. Pipes 24C and 24D respectively divided from the pipes 24A and 24B are connected to the air cylinder 23. A channel switching valve 25 is connected between the pipe 24E connected to a pressure supply source via a pressure adjusting valve 26 and the pipes 24A and 24B. The channel switching valve 25 is switched, whereby the air cylinders 22 and 23 are actuated and the inspection heads 3A and 3B are lifted or lowered. Note that a mechanism for lifting or lowering the inspection heads 3A and 3B is not limited to the air cylinders. Another actuator such as an electric cylinder may be used.

The pressure supplying part 7 simultaneously feeds a supply pressure to the inspection heads 3A and 3B respectively mounted on the containers W1 and W2 and raises the pressures in the sealed containers W1 and W2 to an inspection pressure. Specifically, the pressure supplying part 7 includes channel switching valves 32 and 33 connected to the pressure supplying pipes 30 and 31. A pipe 35 connected to the pressure supply source via the pressure adjusting valve 34 and a pipe 36 divided from the pipe 35 are respectively connected to the channel switching valves 32 and 33. The channel switching valves 32 and 33 are simultaneously switched to the inspection heads 3A and 3B side, whereby the supply pressure is simultaneously fed to the inspection heads 3A and 3B. Thereafter, after a predetermined time elapses and a container internal pressure reaches the inspection pressure, the channel switching valves 32 and 33 are simultaneously switched to a closed side. The pressure supply is stopped and the containers W1 and W2 come into a sealed state.

Setting of the supply pressure in the pressure supplying part 7 is desirably set rather high with respect to the inspection pressure applied in the containers W1 and W2. By setting the supply pressure higher than the inspection pressure, it is possible to reduce a pressurizing time in the containers W1 and W2.

The leakage determination part 8 detects a pressure change over time in the containers W1 and W2 sealed by the inspection heads 3A and 3B and performs leakage determination of the containers W1 and W2. The leakage determination part 8 includes a differential pressure sensor 42 that detects a differential pressure in the two containers W1 and W2. The other ends of the pressure detecting pipes 40 and 41, one ends of which are connected to the inspection heads 3A and 3B, are connected to the differential pressure sensor 42.

In an example shown in FIG. 1, in the leakage determination part 8, the other ends of the pressure detecting pipes 40 and 41 are further divided and connected to direct pressure sensors 43 and 44. A pressure detecting part 45 is configured by the differential pressure sensor 42 and the direct pressure sensors 43 and 44. The direct pressure sensors 43 and 44 directly detect the internal pressures of the respective containers W1 and W2. By dividing the other ends of the pressure detecting pipes 40 and 44 and connecting to the direct pressure sensors 43 and 44, it is possible to simultaneously detect the differential pressure in the containers W1 and W2 detected by the differential pressure sensor 42 and the internal pressures of the respective containers W1 and W2 detected by the direct pressure sensors 43 and 44.

The leakage determination part 8 includes an arithmetic processing part 46. Outputs of the differential pressure sensor 42 and the direct pressure sensors 43 and 44 are input to the arithmetic processing part 46. The arithmetic processing part 46 determines, based on the outputs of the differential pressure sensor 42 and the direct pressure sensors 43 and 44, whether or not a leakage is present in the containers W1 and W2.

The pressure detecting pipes 40 and 41 connected to the leakage determination part 8 are connected to the inspection heads 3A and 3B in a state in which the pressure detecting pipes 40 and 41 are separated from the pressure supplying pipes 30 and 31 connected to the pressure supplying part 7. By connecting the pressure supplying pipes 30 and 31 and the pressure detecting pipes 40 and 41 to the inspection heads 3A and 3B in the separated state in this way, it is possible to reduce a hunting time that occurs during the operation of the channel switching valves 32 and 33.

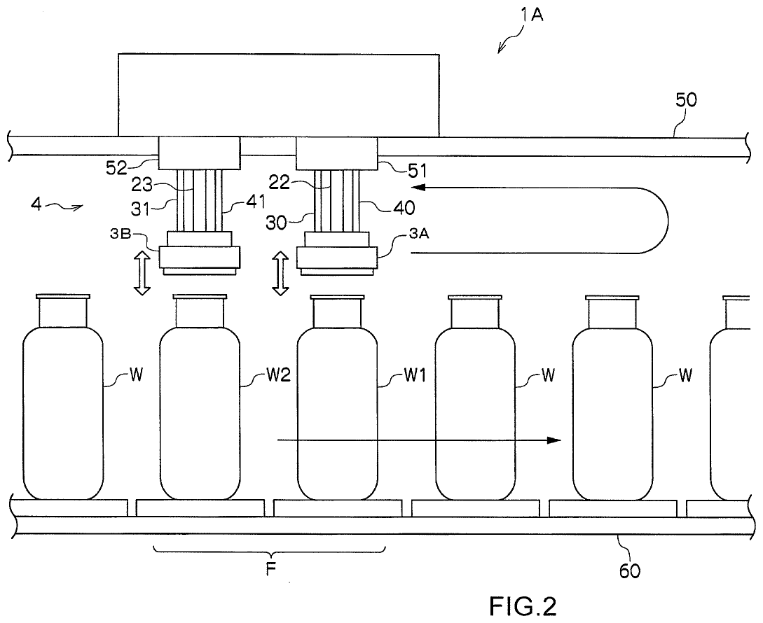

FIG. 2 shows a setting example of the leakage inspection device 1A. The leakage inspection device 1A sets, as inspection targets, the plurality of neighboring containers W1 and W2 among the containers W alignedly conveyed in a row by a conveyance device 60 such as a conveyor and sequentially performs a leakage inspection of the containers W while transferring the inspection heads 3A and 3B along a conveyance direction of the containers W. Therefore, in the leakage inspection device 1A, a guiderail 50 is provided along the conveyance direction of the conveyance device 60. The leakage inspection device 1A includes transfer mechanisms 51 and 52 that transfer the inspection heads 3A and 3B along the guiderail 50.

The transfer mechanisms 51 and 52 transfer the inspection heads 3A and 3B in synchronization with the conveyance of the containers W1 and W2 and transfer the inspection heads 3A and 3B in the opposite direction of the conveyance direction. After the inspection heads 3A and 3B are mounted on the containers W1 and W2, the transfer mechanisms 51 and 52 transfer the inspection heads 3A and 3B at the same speed as transfer speed of the conveyance device 60. After the inspection heads 3A and 3B are separated from the containers W1 and W2, the transfer mechanisms 51 and 52 start an initial position returning operation, transfer the inspection heads 3A and 3B in the opposite direction of the conveyance direction at higher transfer speed, and come into a standby state. Note that, although not shown in the figure, a sensor that detects the containers W may be disposed on the conveyance device 60. The mounting of the inspection heads 3A and 36 on the containers W and the transfer by the transfer mechanisms 51 and 52 may be individually performed according to timing when the containers W are detected. This makes it possible to surely mount the inspection heads 3A and 3B on containers even if there is fluctuation in pitches of the containers W.

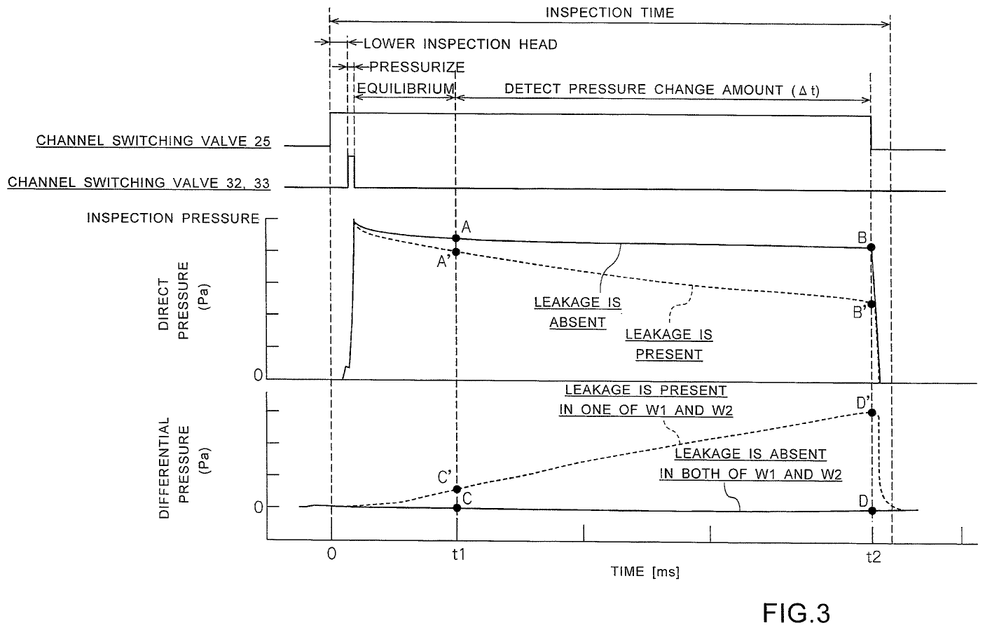

A method of leakage inspection by the leakage inspection device 1A is explained with reference to FIG. 3. At the start of an inspection, first, the inspection heads 3A and 3B are mounted on the mouth parts of the containers W1 and W2 by the head mounting part 4 (a head mounting step). In an example shown in FIG. 2, the transfer of the transfer mechanisms 51 and 52 is synchronized with the transfer of the conveyance device 60. The air cylinders 22 and 23 are actuated by the switching operation of the channel switching valve 25 to lower the inspection heads 3A and 3B.

When the mounting of the inspection heads 3A and 36 is completed, the supply pressure is simultaneously fed to the inspection heads 3A and 3B by the pressure supplying part 7 to pressurize the insides of the containers W1 and W2 and raise the pressures in the containers W1 and W2 to the inspection pressure (a pressure supplying step). The application of the supply pressure is performed by the simultaneous switching of the channel switching valves 32 and 33 in the pressure supplying part 7. The channel switching valves 32 and 33 are switched to an open side to turn on the supply pressure. Thereafter, after a predetermined time elapses, the channel switching valves 32 and 33 are switched to a closed side to turn off the supply pressure. The container internal pressures are maintained at the inspection pressure.

The applied supply pressure is desirably set higher than the inspection pressure as explained above. It is possible to reduce a pressurizing time by setting the supply pressure high. A predetermined equilibrium period is provided after the application of the inspection pressure. A leakage determination step explained below is performed after stabilizing a pressure state in the containers W1 and W2. However, it is possible to reduce the equilibrium period by separating the pressure detecting pipes 40 and 41 to a secondary side of the containers W1 and W2 with respect to the pressure supplying pipes 30 and 31.

Thereafter, a pressure change amount over time in the sealed containers W1 and W2 is detected. Leakage determination of the containers W1 and W2 is performed (a leakage determination step). A pressure change amount is detected with outputs of the differential pressure sensor 42 and the direct pressure sensors 43 and 44. The leakage determination part 8 mainly detects the differential pressure in the containers W1 and W2 with the differential pressure sensor 42 and performs leakage determination based on the differential pressure. The leakage determination part 8 supplementarily detects the internal pressures of the respective containers W1 and W2 with outputs of the direct pressure sensors 43 and 44. The direct pressure sensors 43 and 44 can be omitted as appropriate according to an inspection situation.

In the leakage determination step, first, internal pressures of the respective containers W1 and W2 at a point in time when the pressurizing time ends are measured by the direct pressure sensors 43 and 44. When the internal pressures have not reached the inspection pressure, it is determined that a large leakage is present. When the internal pressures have reached the inspection pressure, pressures detected after elapse of a time t1 from the inspection start (pressure at an A point or an A′ point and a differential pressure at a C point or a C′ point in the figure) and pressures detected after elapse of a Δt time and elapse of a time t2 from the inspection start (pressure at a B point or a B′ point and a differential pressure at a D point or a D′ point shown in the figure) are compared to calculate a pressure change amount.

As the leakage determination with the output of the differential pressure sensor 42, a value obtained by subtracting the differential pressure detected at the C point or the C′ point from the differential pressure detected at the D point or the D′ point shown in a graph of a differential pressure of FIG. 3 (pressure change amount of the differential pressure) is compared with a set threshold. When a pressure change amount of the differential pressure exceeds the threshold, it is determined that a leakage is present in one of the containers W1 and W2. When the pressure change amount of the differential pressure does not exceed the threshold, it is determined that a leakage is absent in both of the containers W1 and W2. In the graph of the differential pressure of FIG. 3, an inspection waveform of the differential pressure in the case of absence of a leakage in both of the containers W1 and W2 is indicated by a solid line. An inspection waveform of the differential pressure in the case of presence of a leakage in one of the containers W1 and W2 is indicated by a broken line. When a leakage is absent in both of the containers W1 and W2, the pressure change amount of the differential pressure is nearly 0 Pa. However, when a leakage is present in one of the containers W1 and W2, the pressure change amount of the differential pressure increases as time elapses.

When it is determined that a leakage is present, it is possible to determine, according to a positive or a negative of an output of the differential pressure sensor 42, on which side of the containers W1 and W2 the leakage is present. In a rare case, when equivalent leakages are present in both of the containers W1 and W2, the pressure change amount of the differential pressure does not exceed the threshold. In order to avoid wrong determination in such a case, the direct pressure sensors 43 and 44 are supplementarily provided. It is possible to determine presence or absence of a leakage in the respective containers W1 and W2 with outputs of the direct pressure sensors 43 and 44.

In the leakage determination with the outputs of the direct pressure sensors 43 and 44, a value obtained by subtracting the pressure detected at the B point or the B′ point from the pressure detected at the A point or the A′ point shown in a graph of a direct pressure of FIG. 3 is compared with a set threshold. When the value exceeds the threshold, it is determined that a leakage is present. When the value does not exceed the threshold, it is determined that a leakage is absent. As shown in FIG. 3, in an inspection waveform of the direct pressure, when a leakage is absent, the pressure change amount is nearly 0 Pa as indicated by a solid line. When a leakage is present, the pressure change amount is a large value as indicated by a broken line.

As shown in FIG. 3, an inspection time for the containers W1 and W2 is, after the channel switching valve 25 is switched to lower the inspection heads 3A and 3B and the pressure supplying step and the leakage determination step are performed, until the inspection heads 3A and 3B are separated from the containers W1 and W2 and preparation for lowering of the inspection heads 3A and 3B for the next plurality of containers.

In the example shown in FIG. 2, after the inspection heads 3A and 3B are mounted on the containers W1 and W2, the pressure supplying step and the leakage determination step are performed while transferring the inspection heads 3A and 3B according to conveyance of the containers W1 and W2. After the leakage determination step, the inspection heads 3A and 3B are separated from the containers W1 and W2 and returned to an initial position. The inspection heads 3A and 3B are transferred in the opposite direction of the conveyance direction of the containers W1 and W2 at higher transfer speed. The inspection heads 3A and 3B are returned to an initial position F and come into the standby state.

With such a leakage inspection method using the leakage inspection device 1A, the plurality of containers W1 and W2 having substantially equal temperatures of containers that have been alignedly conveyed from the container manufacturing line are set as targets. The leakage determination is performed according to the differential pressure in the containers. Therefore, it is possible to perform the leakage determination without considering a change in the container temperatures. This makes it unnecessary to perform adjustment of the threshold considering a change in the container temperature and makes it possible to perform leakage determination with high productivity.

The differential pressure in the plurality of containers W1 and W2 has a small absolute value of a pressure change amount over time. Therefore, it is possible to detect a pressure change with high sensor sensitivity by associating a small change of the absolute value with a full range of the differential pressure sensor 42. This makes it possible to realize highly accurate leakage determination and detect a leakage due to a very small pinhole without overlooking the leakage.

As indicated by the setting example shown in FIG. 2, the leakage inspection device 1A can be incorporated in the container conveyance process. Therefore, it is possible to save a leakage inspection space. Further, it is possible to perform a leakage inspection making use of a tact time of the container conveyance process. This also makes it possible to obtain high productivity.

The leakage inspection device 1A sets the supply pressure high with respect to the inspection pressure to reduce the pressurizing time. The equilibrium period after the pressure supply can be set short by connecting the pressure supplying pipes 30 and 31 and the pressure inspection pipes 40 and 41 to the inspection heads 3A and 3B in such a manner that the pressure supplying pipes 30 and 31 and the pressure inspection pipes 40 and 41 are separated from each other. Therefore, it is possible to set the elapsed time Δt for detecting the pressure change amount to be long within a limited range of the inspection time. This makes it possible to perform leakage determination with high certainty.

Note that, in the embodiment of the present invention explained above, the leakage inspection is performed on the neighboring containers W1 and W2. However, the leakage inspection can also be performed on three or more containers W. In that case, combinations of pairs are optional. For example, in three containers W1, W2, and W3, combinations of pairs may be W1-W2 and W2-W3 or W1-W2 and W1-W3. In this way, when the number of containers to be processed increases, the parts (the head mounting part 4, the pressure supplying part 7, and the leakage determination part 8) of the leakage inspection device are increased as appropriate according to the number of containers to be processed.

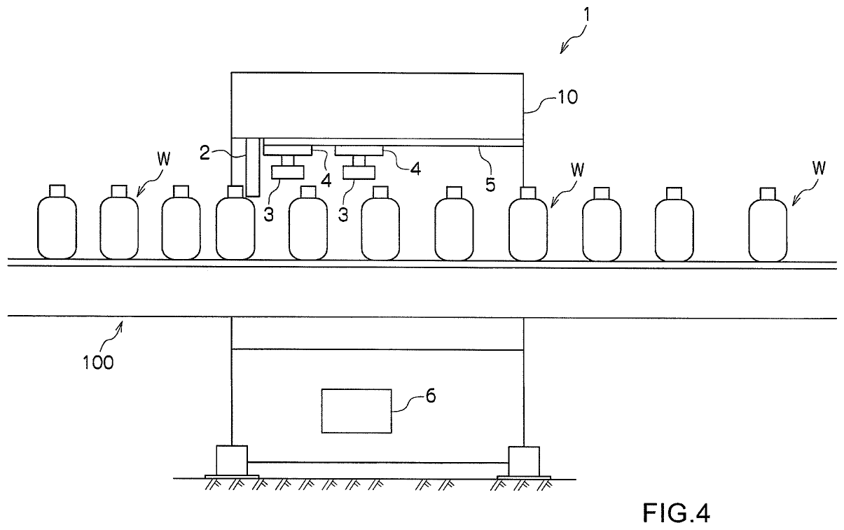

In FIG. 4, a conveyed container processing device (hereinafter, processing device) 1 is explained. The processing device 1 is a device that performs leakage inspection processing, cleaning processing, filling processing, and the like on a plurality of containers W linearly conveyed by a conveyance device 100 such as a conveyer. In the following explanation, the processing device 1 can be used in the leakage inspection device shown in FIG. 1 but is not limited to this.

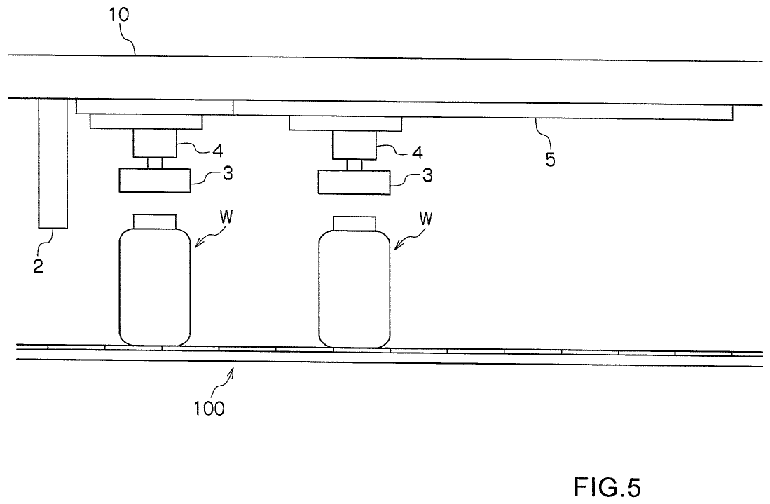

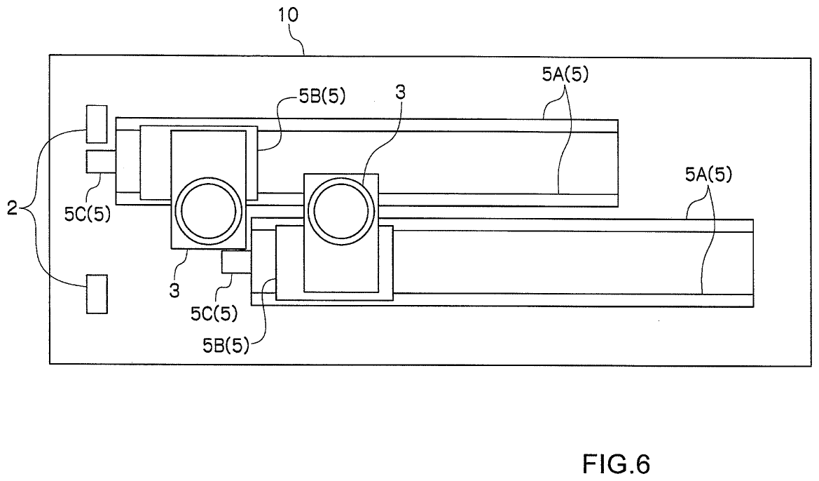

The processing device 1 includes a device main body 10, a container sensor 2, processing heads 3, head mounting parts 4, linear actuators 5, and a controller 6. These main components are shown in FIG. 5 and FIG. 6.

The container sensor 2 is provided in the device main body 10. The container sensor 2 detects the containers W linearly conveyed at an interval by the conveyance device 100. The container sensor 2 transmits a detection signal to the controller 6 at timing when the container W conveyed by the conveyance device 100 passes a setting part (an origin) of the container sensor 2. As the container sensor 2, various sensors of a contact type and a non-contact type can be used.

The processing heads 3 are mounted on the mouth parts of the containers W and perform various kinds of processing. When a leakage inspection is performed, the processing heads 3 are the inspection heads 3A and 3B explained above. The processing heads 3 seal the containers W, apply the inspection pressure in the containers W, and thereafter detect a pressure change in the containers W. As shown in FIG. 1 the head mounting parts 4 mount the processing heads 3 (the inspection heads 3A and 3B) on the mouth parts of the containers W and separate the processing heads 3 from the mouth parts of the containers W. As explained above, the head mounting parts 4 include lifting and lowering means such as an air cylinder and lift and lower the processing heads 3 up and down.

The linear actuators 5 reciprocally transfer the head mounting parts 4 along the conveyance path of the containers W. The linear actuators 5 includes guiderails 5A disposed along the conveyance device 100 that linearly transfers the containers W, transfer members 5B that reciprocally transfer along the guide rails 5A, and driving motors (e.g., stepping motors) 5C that transfer the transfer members 5B to predetermined positions.

The controller 6 receives a detect signal of the container sensor 2 and controls the head mounting parts 4 and the linear actuators 5. The processing heads 3 may independently operate according to operation timing of the head mounting part 4 or may be controlled to operate by the controller 6.

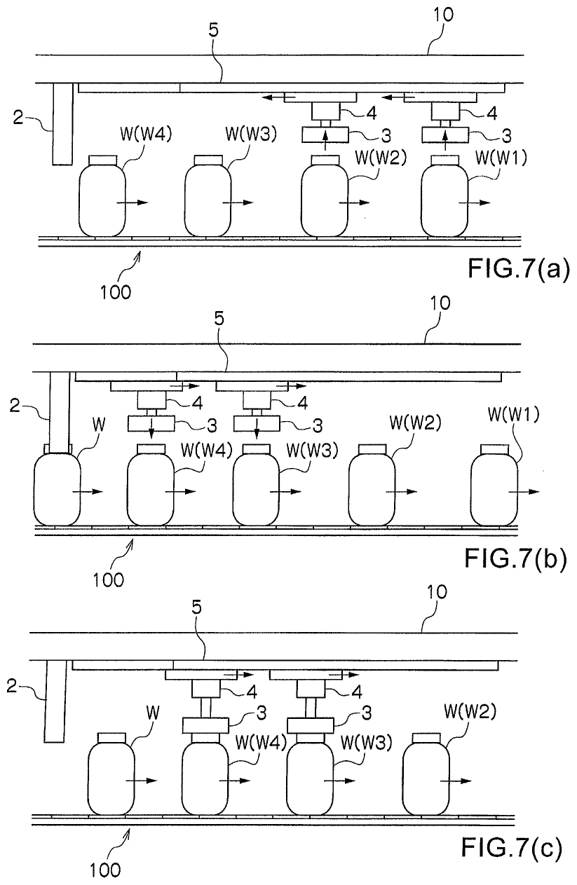

FIG. 7 shows the operations of the head mounting parts 4 and the linear actuators 5 controlled by the controller 6. The controller 6 calculates a transfer distance of a plurality of conveyed containers W from detection timing of the container sensor 2 and an output of an encoder (not shown in the figure) attached to a motor of the conveyance device 100 and recognizes the positions of the respective containers W. The transfer distance of the containers W can also be calculated from the detection timing of the container sensor 2, conveyance speed of the conveyance device 100, and elapsed times of the respective containers W. In that case, as the conveyance speed of the conveyance device 100, preset speed may be input to the controller 6 or speed detected by separately provided speed detecting means may be input to the controller 6.

When processing for a plurality of continuously conveyed containers W (W1 and W2) among the linearly conveyed containers W ends, as shown in FIG. 7(a), the controller 6 separates the processing heads 4 from the mouth parts of the containers W (W1 and W2) and prepares for processing for the next unprocessed containers.

Thereafter, the controller 6 controls the linear actuators 5 in order to transfer the processing heads 3 onto the next unprocessed containers W (W3 and W4), the positions of which are already recognized, according to detection of the container sensor 2 and transfers the head mounting parts 4. As shown in FIG. 7(b), when the processing heads 3 reach above the next unprocessed containers W (W3 and W4), the controller 6 controls the linear actuators 5 to transfer the processing heads 3 above the conveyed containers W (W3 and W4) and causes the head mounting parts 4 to follow the transfer of the containers W (W3 and W4).

When the processing heads 3 reach above the unprocessed containers W (W3 and W4), the controller 6 controls the head mounting parts 4 to mount the processing heads 3 on the mouth parts of the plurality of containers W (W3 and W4). As shown in FIG. 7(c), the controller 6 performs processing (e.g., the leakage inspection processing) by the processing heads 3 while causing the head mounting parts 4 to follow the transfer of the containers W (W3 and W4). After the processing ends, the controller 6 repeats the operation shown in FIG. 7(a) to FIG. 7(c) for the next unprocessed containers W.

When the controller 6 performs the control explained above, it is possible to individually mount the processing heads 3 on a processing target plurality of containers W (in the example shown in the figures, two containers) among the containers W linearly conveyed at various intervals and simultaneously perform processing for the plurality of containers W. In this case, the head mounting parts 4 and the linear actuators 5 controlled by the controller 6 need to be disposed in parallel by the number of the containers W (in the example shown in the figures, two) for which simultaneously processing is performed. The processing heads 3 respectively provided in the plurality of head mounting parts 4 need to be linearly disposed along a row of the conveyed containers W.

The processing device 1 can be used as the leakage inspection device 1A of a differential pressure type shown in FIG. 1. The leakage inspection device 1A is equipped with the pressure supplying part 7 and the leakage determination part 8 with respect to the inspection heads 3A and 3B, which are the processing heads 3, and the head mounting parts 4 explained above.

The processing device 1 not only can be used as the leakage inspection device 1A of the differential pressure type explained above but also can be used as a leakage inspection device of a straight pressure type and other processing devices for cleaning, filling, and the like. In this case, the processing device 1 can be externally disposed with respect to any conveyance device having fluctuation in conveyance intervals without using, in the conveyance device, means for positioning the containers W at equal intervals. The processing heads 1 can be surely mounted on the plurality of conveyed containers W. It is possible to improve a processing ability by simultaneously processing the plurality of containers W.

The embodiments of the present invention are explained in detail above with reference to the drawings. However, a specific configuration is not limited to these embodiments. Even changes and the like of design in a range not departing from the spirit of the present invention are included in the present invention. The techniques of the embodiments explained above can be diverted and combined as long as there is no particular contradiction and problem in the purposes, the configurations, and the like of the embodiments.

1.-10. (canceled)

11. A conveyed container processing device comprising:
a container sensor that detects a linearly conveyed container;
a plurality of head mounting parts that mount processing heads respectively on mouth parts of a plurality of containers detected by the container sensor;
a plurality of linear actuators that reciprocally transfer the head mounting parts along a conveyance path of containers; and
a controller that respectively individually controls operations of the plurality of linear actuators and the plurality of head mounting parts, wherein
the controller respectively recognizes positions of the plurality of conveyed containers on the basis of a detection timing of the container sensor and a transfer distance of the containers and controls the linear actuators to transfer the processing heads respectively onto the plurality of containers detected by the container sensor and thereafter cause the head mounting parts to follow the transfer of the containers.

12. The conveyed container processing device according to claim 11, wherein the controller controls the head mounting parts to mount, on the containers, the processing heads transferred onto the containers and separates the processing heads from the containers after processing.

13. The conveyed container processing device according to claim 11, wherein the processing heads are inspection heads that apply an inspection pressure in the containers and detect a pressure change after the application of the inspection pressure.

14. A leakage inspection device for container using the conveyed container processing device according to claim 13, wherein
the head mounting parts mount inspection heads respectively on mouth parts of a plurality of containers among containers alignedly conveyed from a container manufacturing line,
the leakage inspection device for container further comprising:
a pressure supplying part that simultaneously feeds a supply pressure to the inspection heads respectively mounted on the plurality of containers to control pressure in the plurality of sealed containers to an inspection pressure; and
a leakage determination part that detects a pressure change over time in the plurality of sealed containers and performs leakage determination of the plurality of containers, wherein
the leakage determination part includes a differential pressure sensor that detects a differential pressure in a pair of containers of the plurality of containers, and the leakage determination part performs the leakage determination on the basis of an output of the differential pressure sensor.

15. The leakage inspection device for container according to claim 14, wherein the leakage determination part includes a direct pressure sensor that detects internal pressures of the plurality of respective containers simultaneously with the differential pressure.

16. The leakage inspection device for container according to claim 14, wherein a pressure supplying pipe connected to the pressure supplying part and a pressure detecting pipe connected to the leakage determination part are connected to the inspection heads in such a manner that the pressure supplying pipe and the pressure detecting pipe are separated from each other.

17. The leakage inspection device for container according to claim 14, wherein the linear actuator transfers the inspection heads mounted on a plurality of containers in synchronization with conveyance of the plurality of containers and transfers, in an opposite direction of a conveyance direction of the containers, the inspection heads separated from the plurality of containers after an inspection.

18. A leakage inspection method for container using the conveyed container processing device according to claim 13, the leakage inspection method comprising:
a head mounting step of mounting the inspection heads respectively on mouth parts of a plurality of containers among containers alignedly conveyed from a container manufacturing line;
a pressure supplying step of simultaneously feeding a supply pressure to the inspection heads respectively mounted on the plurality of containers and controlling pressures in the plurality of sealed containers to an inspection pressure; and
a leakage determination step of detecting a pressure change over time in the plurality of sealed containers and performing leakage determination of the plurality of containers, wherein
in the leakage determination step, a differential pressure in a pair of containers of the plurality of containers is detected, and the leakage determination is performed based on the differential pressure.

19. The leakage inspection method for container according to claim 18, wherein, in the leakage determination step, internal pressures of the plurality of respective containers are detected simultaneously with the differential pressure.

20. The leakage inspection method for container according to claim 18, wherein
the pressure supply step and the leakage determination step are performed while transferring the inspection heads mounted on the plurality of containers in synchronization with the conveyance of the plurality of containers, and
after the leakage determination step, the inspection heads are separated from the plurality of containers and transferred in an opposite direction of a conveyance direction of the plurality of containers.
